(19) United States
(12) Patent Application Publication
(10) Pub. No.: US 2007/0204495 A1
(43) Pub. Date: Sep. 6, 2007

(54) Cup structure with surfaces of changeable patterns

(76) Inventor: Chang-Fa Lee, Taipei (TW)

Correspondence Address: BACON & THOMAS, PLLC, 625 SLATERS LANE, FOURTH FLOOR, ALEXANDRIA, VA, 22314, US

(21) Appl. No.: 11/366,439

(22) Filed: Mar. 3, 2006

(51) Int. Cl. G09F 3/00

(52) U.S. Cl. 40/324

(57) ABSTRACT

The present invention discloses a cup structure with surfaces of changeable patterns, and the structure includes a cup body, a transparent containing space having a surrounding periphery and disposed in the cup body, at least one driving shaft and driven shaft disposed at the containing space, and reel surrounded the periphery of a reel and wound on a driving shaft and a driven shaft, and the reel contains various different patterns or a continuous essay, such that when the cup structure is in use, the driving shaft and driven shaft can be rotated to change the pattern portion of the reel at the periphery of the cup body, and the patterns or words on the reel can be rotated to constantly change and display the patterns or words, so as to arouse children's curiosity, give more fun of using the cup, and encourage children to drink more water.

### BACKGROUND OF THE INVENTION

1. Field of the Invention

The present invention relates to a cup structure with surfaces of changeable patterns, and more particularly to a cup structure installed at the periphery of a cup body that utilizes the rotation of a shaft to drive a reel to display a portion of patterns on the periphery of the cup body, so as to attract children's attention and curiosity and further to give more fun for children to use the cup for drinking water.

2. Description of the Related Art

As a cup is an indispensable appliance in our daily life, a cup is always a cup regardless of the material it is made of, and even if a cup body is painted with different figures or pictures, the figures or pictures are still static. Cups of this sort can no longer attract children's attention after a long time of use and thus will reduce the children's willingness of drinking water.

In view of the shortcomings of the foregoing cup structure, some manufacturers have made improvements as disclosed in R.O.C. Application Pat. No. 87211563 (or Publication No. 357587) by providing a light emitting cup structure that comprises a cup body and a base, wherein the cup body is an integral structure having an internal wall, an external wall, and an appropriate gap between the two walls, and the base includes an electroluminescent laminate, a plurality of partitions extended from the bottom of the electroluminescent laminate, and a plurality of containing grooves disposed at the bottom of the base for containing a circuit board, a power supply and a switch electrically connected to the electroluminescent laminate, and a panel is fixed at the bottom of the base and has a through hole corresponding to the power supply, and a detachable cover is installed at the through hole, and the pressing portion of the foregoing switch is protruded from the panel, such that the base can be embedded into the bottom of the cup body, and the electroluminescent laminate on the base is situated precisely in the gap of the cup body to constitute a light emitting cup.

After a power switch is turned on, sufficient electric power is supplied to the circuit board to control the electroluminescent laminate and further light up the electroluminescent laminate. However, the structure of such cup body must have the internal wall, external wall, and gap between the two walls to install the electroluminescent laminate, and thus the manufacturing procedure is very complicated. Further, the base has to contain the circuit board and power supply, and thus the base has relatively large height and weight, which may create a burden for children to use the cup.

### SUMMARY OF THE INVENTION

In view of the shortcomings of the prior art cup structure which is monotonous and boring to use and whose structure is complicated, the inventor of the present invention based on years of experience in the related industry to conduct extensive researches and experiments, and finally invented a cup structure with surfaces of changeable patterns in accordance with the invention.

Therefore, it is a primary objective of the present invention to provide a cup structure with surfaces of changeable patterns to overcome the shortcomings of the prior art, and the cup structure comprises a cup body, and the cup body comprises an internal wall, an external wall, and a containing space. The containing space includes at least one driving shaft and driven shaft disposed on a side of the containing space, and the driving shaft is engaged with the driven shaft by an axle, and the containing space includes a reel. The length of the reel is much larger than the periphery of the cup body, and the surface of the reel includes various different patterns or a continuous essay. Both ends of the reel are wound around the driving shaft and the driven shaft, such that when the cup is used, the driving shaft and the driven shaft are rotated to change the surrounding portion of the cup body around the reel, and thus the patterns or texts on the reel can be rotated and changed constantly to satisfy the children's curiosity. Unlike the prior art cup structure having a complicated manufacturing process, the manufacture of the cup structure of the invention is much simpler, and it thus can save manufacturing costs.

A secondary objective of the present invention is to provide a cup structure with surfaces of changeable patterns, and both ends of the reel are wound around different driving shafts, and these driving shafts keep a specific distance apart, such that when the cup is in use, the two driving shafts are rotated simultaneously, and the reel constantly changes the surrounding portion protruded from the cup body.

A further objective of the present invention is to provide a cup structure with surfaces of changeable patterns that comprises a transmission wheel disposed between the driving shaft and the driven shaft, so as to provide smooth rotations of the reel.

Another objective of the present invention is to provide a cup structure with surfaces of changeable patterns, wherein both ends of the reel are wound around different driving shafts, and these driving shafts keep a specific distance apart, and the bottom of the cup includes a drive circuit and a motor, and the motor includes an axle connected to the driving shaft, such that when the cup is in use, the motor is rotated to constantly change the surrounding portion of the reel protruded from the cup body.

Another further objective of the present invention is to provide a cup structure with surfaces of changeable patterns, and the cup body at its bottom includes a base, and the periphery of the base includes an elastic member, so that when the base is embedded into the containing space, the elasticity of the elastic member fixes the base into its position, so as to achieve the waterproof effect.

### BRIEF DESCRIPTION OF THE DRAWINGS

The present invention will now be described in more detail hereinafter with reference to the accompanying drawings that show various embodiments of the invention, in which:

FIG. 1 is a perspective view of a first preferred embodiment of the invention;

FIG. 2 is an exploded view of a first preferred embodiment of the invention;

FIG. 3 is a top view of a first preferred embodiment of the invention;

FIG. 4 is a cross-sectional view of Section A-A according to a first preferred embodiment of the invention;

FIG. 5 is a perspective view of a second preferred embodiment of the invention;

FIG. 6 is a top view of a second preferred embodiment of the invention;

FIG. 7 is a cross-sectional view of Section B-B according to a second preferred embodiment of the invention;

FIG. 8 is a perspective view of a third preferred embodiment of the invention;

FIG. 9 is a top view of a third preferred embodiment of the invention;

FIG. 10 is a cross-sectional view of Section C-C according to a third preferred embodiment of the invention;

FIG. 11 is an exploded view of a fourth preferred embodiment of the invention;

FIG. 12 is a top view of a fourth preferred embodiment of the invention; and

FIG. 13 is a cross-sectional view of Section D-D according to a fourth preferred embodiment of the invention.

### DETAILED DESCRIPTION OF THE PREFERRED EMBODIMENTS

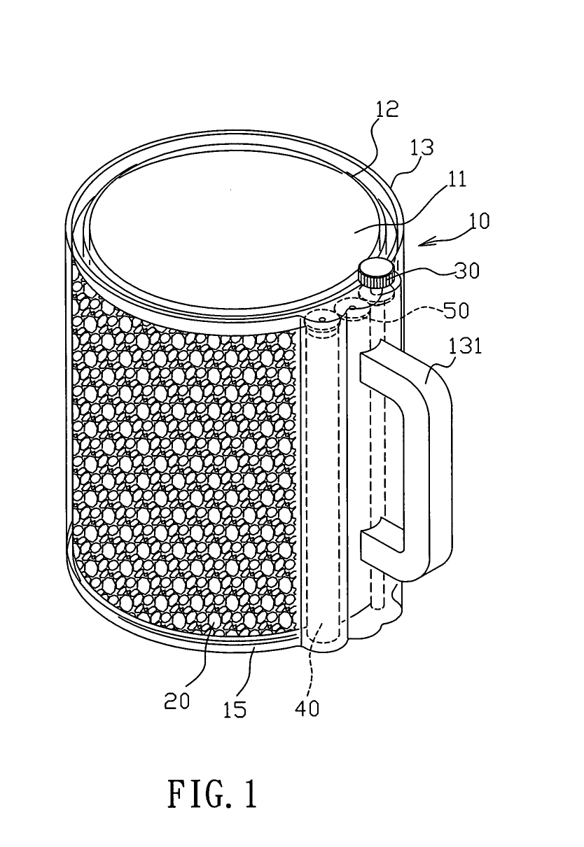

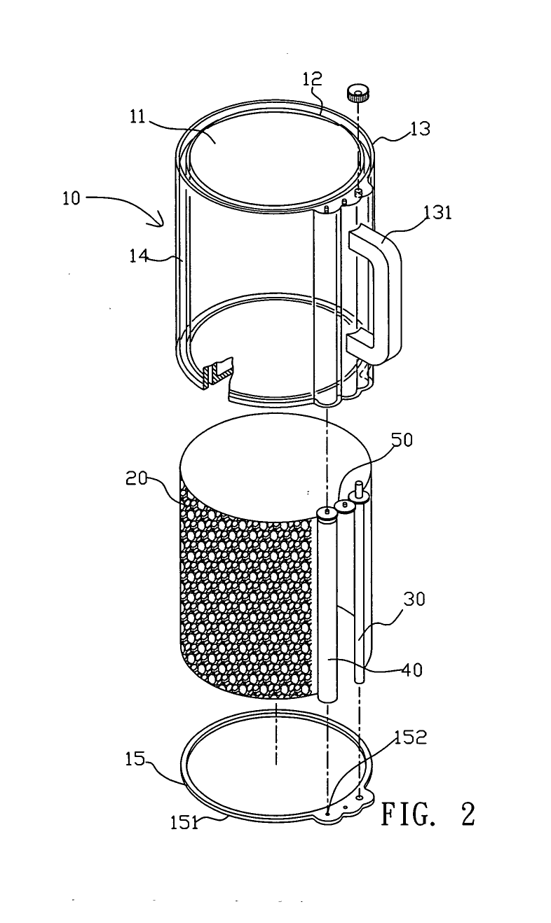

Referring to FIGS. 1 to 3 for the preferred embodiment of a cup structure with surfaces of changeable patterns in accordance with the present invention, the cup structure includes a cup body 10, and the cup body 10 includes a water containing groove 11, and the water containing groove 11 includes an internal wall 12 and an external wall 13 around the periphery of the water containing groove 11, wherein the surface of the external wall 13 has a handle 131 for users to carry, and the internal and external walls 12, 13 include a transparent containing space 14 therebetween, and an end of the containing space 14 is a closed end, and the other end of the containing space 14 is an open end. The open end of the containing space 14 includes a base 15, and the base 15 could be a circular hollow frame or panel, and the periphery of the base 15 includes an elastic member 151 which is a silicon gel band adopted by this preferred embodiment, such that when the base 15 is embedded into the containing space 14, the elasticity of the elastic member 151 fixes the base 15 into its position, so as to achieve the waterproof effect.

Further, a reel 20 is disposed around the containing space 14, and the length of the reel 20 is much larger than the periphery of the cup body 10, and the surface of the reel 20 has various different patterns or a continuous essay, and both ends of the reel 20 are wound on the driving shaft 30 and the driven shaft 40 at one side of the cup body 10. In this preferred embodiment, the driving shaft 30 and the driven shaft 40 are situated proximate to the handle 131, and one end of the driving shaft 30 and the driven shaft 40 is pivotally coupled to a concave hole 152 of the base 15, and the other end is pivotally coupled to the closed end of the containing space 14, wherein the end of the driving shaft 30 is protruded from the containing space 14 for users to hold, and a transmission wheel axle 50 is installed between the driving shaft 30 and the driven shaft 4, and the transmission wheel axle 50 is engaged with the driving shaft 30 and the driven shaft 40.

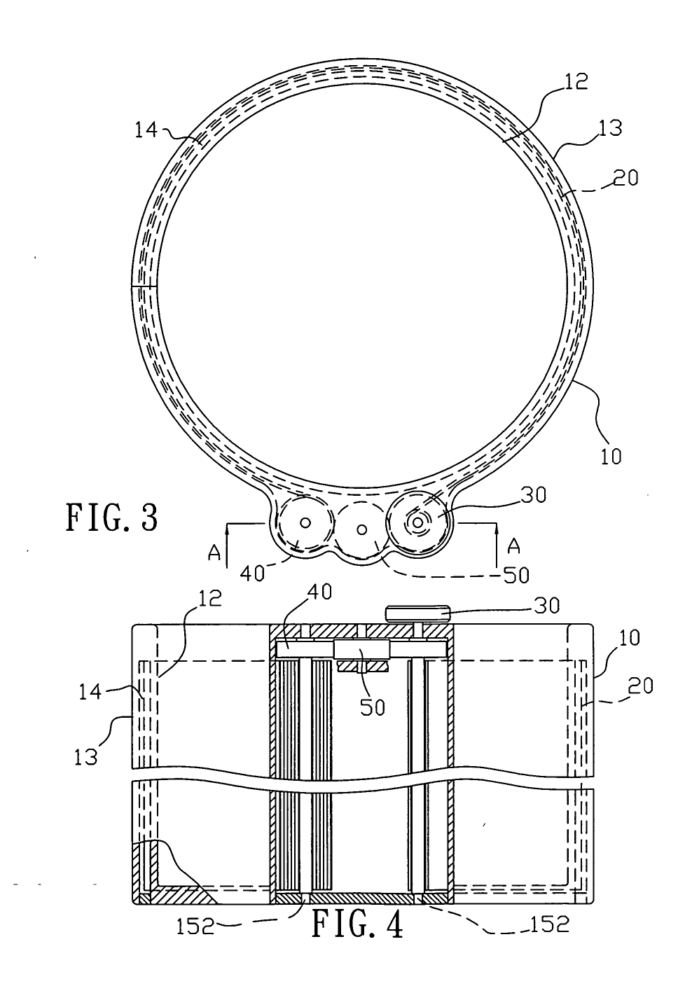

Referring to FIGS. 3 and 4 for the use of the invention, it is necessary to rotate the driving shaft 30 only, and then the transmission wheel axle 50 engaged with the driving shaft 30 will drive the driven shaft 40 to rotate accordingly, and a portion of the reel 20 is wound around the periphery of the driven shaft 40, and a portion of the reel 20 is wound around the periphery of the cup body 10, so as to give more fun to the drinking and encourage children to drink more water.

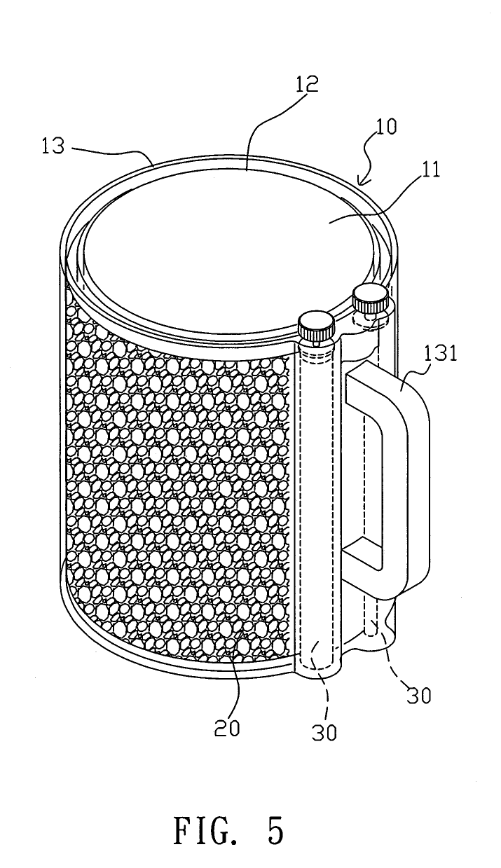

Referring to FIGS. 5 to 7 for the second preferred embodiment of the present invention, the cup structure includes a cup body 10, and the cup body 10 includes a water containing groove 11, and the water containing groove 11 includes an internal wall 12 and an external wall 13 around the periphery of the water containing groove 11, wherein the surface of the external wall 13 has a handle 131 for users to carry, and the internal and external walls 12, 13 include a transparent containing space 14 therebetween, and an end of the containing space 14 is a closed end, and the other end of the containing space 14 is an open end. The open end of the containing space 14 includes a base 15, and the base 15 could be a circular hollow frame or panel, and the periphery of the base 15 includes an elastic member 151 which is a silicon gel band adopted by this preferred embodiment, such that when the base 15 is embedded into the containing space 14, the elasticity of the elastic member 151 fixes the base 15 into its position, so as to achieve the waterproof effect.

Further, a reel 20 is disposed around the containing space 14, and the length of the reel 20 is much larger than the periphery of the cup body 10, and the surface of the reel 20 has various different patterns or a continuous essay, and both ends of the reel 20 are wound on the driving shaft 30 at one side of the cup body 10. In this preferred embodiment, the driving shaft 30 is disposed proximate to handle 131, and the driving shafts 30 keep a specific distance apart, and one end of the driving shafts 30 is pivotally coupled to a concave hole 152 of the base 15, and the other end is pivotally coupled to the closed end of the containing space 14, and the end of the driving shaft 30 is protruded from the containing space 14.

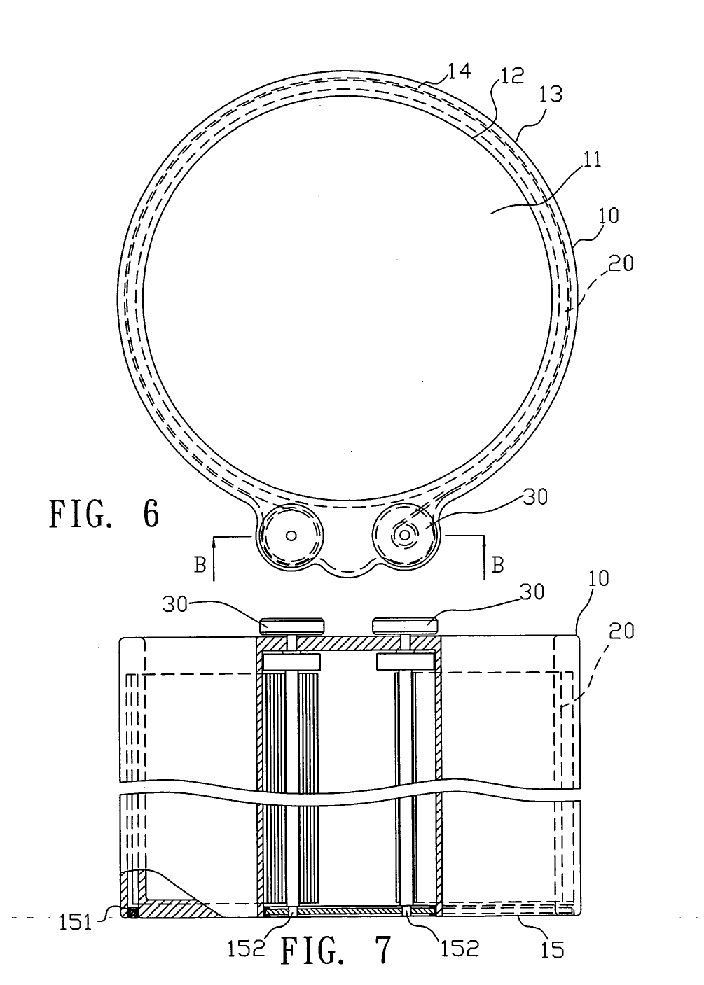

Referring to FIGS. 6 and 7 for the use of the invention, it is necessary to rotate the driving shaft 30 only, and thus the rotation of the driving shaft 30 drives another end of the reel 20 to move outward, and another end will be wound around the periphery of the driving shaft 30, and different portions of the reel 20 will be displayed around the periphery of the cup body 10, so as to give more fun to children for drinking water.

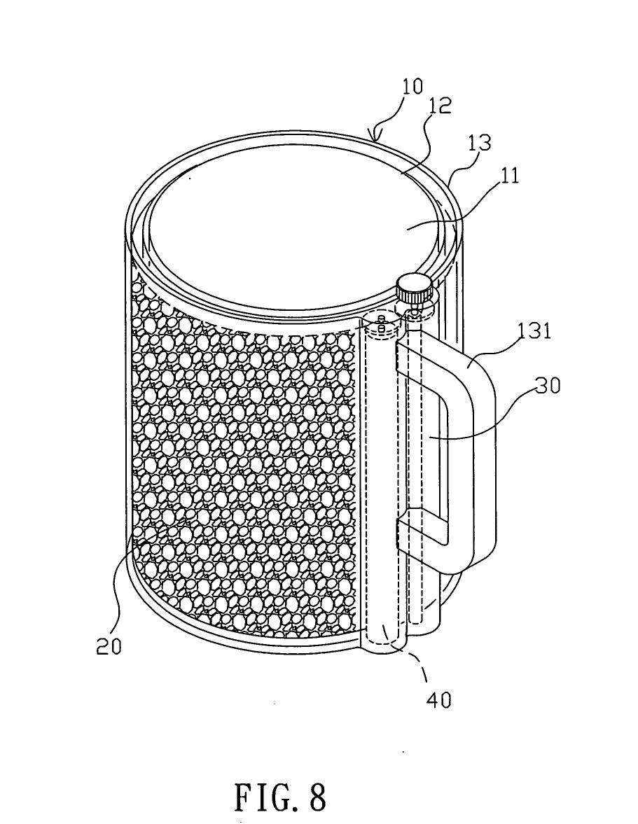

Referring to FIGS. 8 to 10 for the third preferred embodiment of the present invention, the cup structure includes a cup body 10, and the cup body 10 includes a water containing groove 11, and the water containing groove 11 includes an internal wall 12 and an external wall 13 around the periphery of the water containing groove 11, wherein the surface of the external wall 13 has a handle 131 for users to carry, and the internal and external walls 12, 13 include a transparent containing space 14 therebetween, and an end of the containing space 14 is a closed end, and the other end of the containing space 14 is an open end. The open end of the containing space 14 includes a base 15, and the base 15 could be a circular hollow frame or panel, and the periphery of the base 15 includes an elastic member 151 which is a silicon gel band adopted by this preferred embodiment, such that when the base 15 is embedded into the containing space 14, the elasticity of the elastic member 151 fixes the base 15 into its position, so as to achieve the waterproof effect.

Further, a reel 20 is disposed around the containing space 14, and the length of the reel 20 is much larger than the periphery of the cup body 10, and the surface of the reel 20 has various different patterns or a continuous essay, and both ends of the reel 20 are wound on the driving shaft 30 and the driven shaft 40 at one side of the cup body 10. In this preferred embodiment, the driving shaft 30 and the driven shaft 40 are situated proximate to the handle 131, and one end of the driving shaft 30 and the driven shaft 40 is pivotally coupled to a concave hole 152 of the base 15, and the other end is pivotally coupled to the closed end of the containing space 14, wherein the end of the driving shaft 30 is protruded from the containing space 14 for users to hold, and the driving shaft 30 and the driven shaft 4 are engaged with each other.

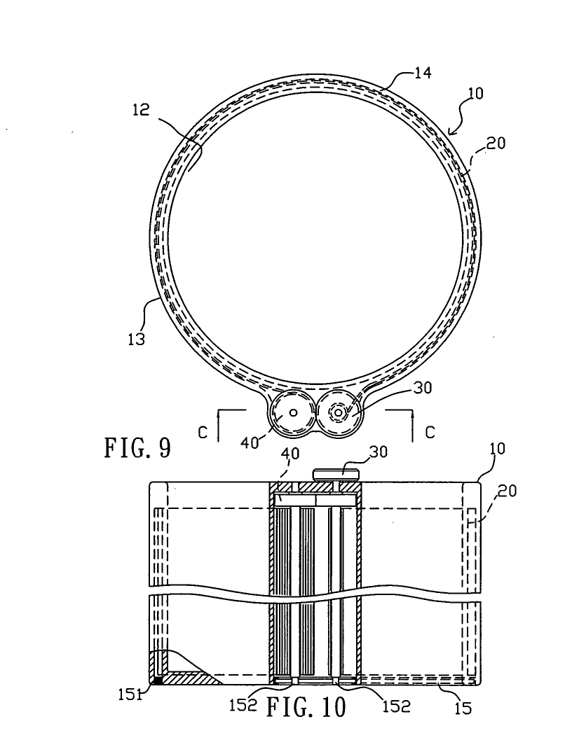

Referring to FIGS. 9 and 10 for the use of the invention, it is necessary to rotate the driving shaft 30 only, and thus the rotation of the driving shaft 30 drives the driven shaft 40 engaged with the driving shaft 30 to rotate accordingly, and a portion of the reel 20 is wound around the driven shaft 40 and a portion of the reel 20 is wound around the cup body 10, so as to give more fun to children for drinking water.

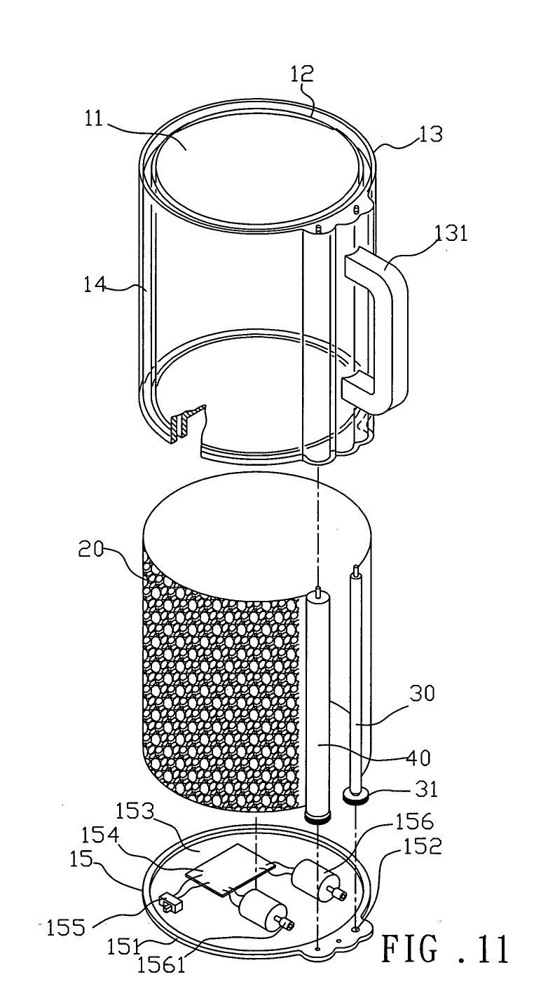

Referring to FIGS. 11 to 13 for the fourth preferred embodiment of the present invention, the cup structure includes a cup body 10, and the cup body 10 includes a water containing groove 11, and the water containing groove 11 includes an internal wall 12 and an external wall 13 around the periphery of the water containing groove 11, wherein the surface of the external wall 13 has a handle 131 for users to carry, and the internal and external walls 12, 13 include a transparent containing space 14 therebetween, and an end of the containing space 14 is a closed end, and the other end of the containing space 14 is an open end. The open end of the containing space 14 includes a base 15, and the base 15 includes a containing space 153 for containing a drive circuit 154 and a motor 156, and the drive circuit 154 and the motor 156 are electrically connected, and the motor 156 includes an axle 1561, and the drive circuit 154 is electrically connected to a switch 155 on the base, and the base includes an elastic member 151 which could be a circular hollow frame or panel, and the periphery of the base 15 includes an elastic member 151 which is a silicon gel band adopted by this preferred embodiment, such that when the base 15 is embedded into the containing space 14, the elasticity of the elastic member 151 fixes the base 15 into its position, so as to achieve the waterproof effect.

Further, a reel 20 is disposed around the containing space 14, and the length of the reel 20 is much larger than the periphery of the cup body 10, and the surface of the reel 20 has various different patterns or a continuous essay, and both ends of the reel 20 are wound on the driving shaft 30 at one side of the cup body 10. In this preferred embodiment, the driving shaft 30 is situated proximate to the handle 131, and the driving shafts 30 keep a specific distance apart, and an end of the driving shaft 30 proximate to the base 15 includes an axle 31. Further, the driving shaft 30 is protruded from the end point of the axle 31 and pivotally coupled into a concave hole 152 of the base 15, and another end of the driving shaft 30 is pivotally coupled to the closed end of the containing space 14. The axle 31 of the driving shaft 30 is engaged withanaxle 1561 of the motor 156.

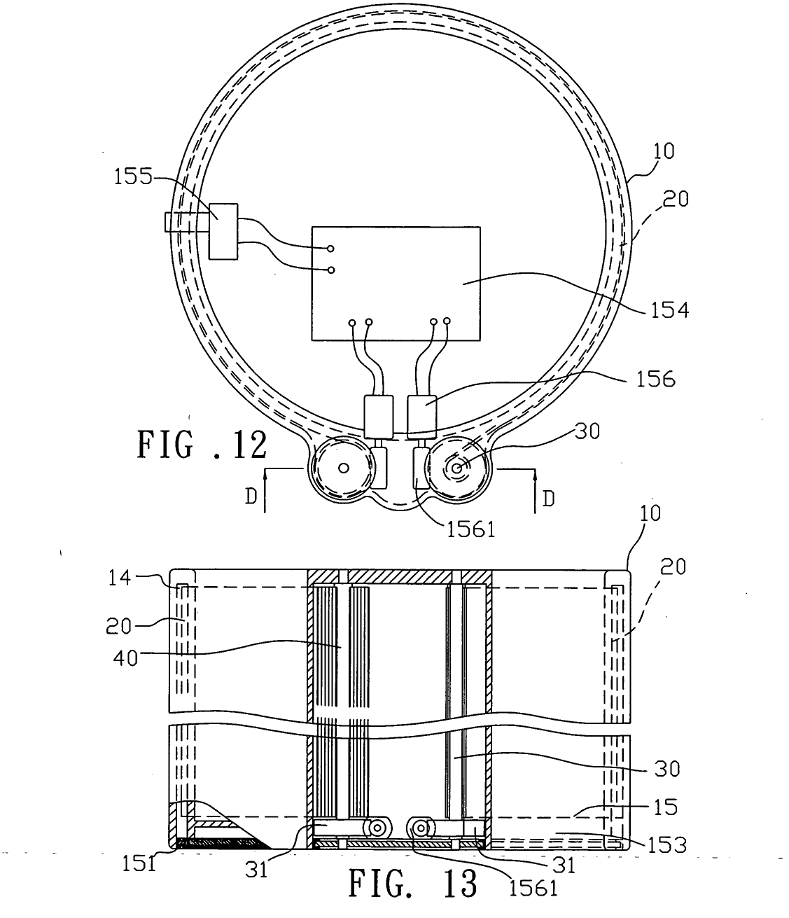

Referring to FIGS. 12 and 13 for the use of the present invention, the switch 155 is pressed to drive the drive circuit 154 to control the rotation of the motor 156, while the axle 1561 of the motor 156 drives the axle 31 and the driving shaft 30 to move an end of the reel 20 outward by the rotation of the driving shaft 30, and another end of the reel 20 is wound into the periphery of the driving shaft 30, so that the reel 20 constantly display different portions and wound around the cup body 10 to give more fun for children to drink water.

In summation of the description above, the cup structure with surface of changeable patterns of the present invention complies with the patent application requirements and is submitted to the Patent and Trademark Office for review and granting of the commensurate patent rights.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A cup structure with surfaces of changeable patterns, comprising:
a cup body, having a containing space disposed at the periphery of said cup body; and
a reel, contained in a containing space of said cup body, and having a length much longer than the periphery of said cup body, a surface with different patterns or a continuous essay, and a driving shaft and a driven shaft wound separately around both ends of said reel;
such that when said cup structure is in use, said driving shaft and said driven shaft are rotated to change the portion at the periphery of said cup body surrounded said reel, and said patterns or texts on said reel can be rotated to constantly change and display said patterns or words, so as to satisfy children's curiosity.

2. The cup structure with surfaces of changeable patterns of claim 1, further comprising a transmission wheel axle disposed between said driving shaft and said driven shaft which are engaged with each other.

3. The cup structure with surfaces of changeable patterns of claim 1, wherein said driven shaft can be substituted by said driving shaft.

4. The cup structure with surfaces of changeable patterns of claim 1, wherein said driving shaft and said driven shaft are engaged with each other.

5. The cup structure with surfaces of changeable patterns of claim 1, wherein said cup body includes a base, and an elastic member disposed at the periphery of said base, such that when the base is embedded into said containing space, the elasticity of said elastic member fixes said base at an appropriate position, so as to achieve a waterproof effect.

6. The cup structure with surfaces of changeable patterns of claim 5, wherein said base is a circular hollow frame.

7. The cup structure with surfaces of changeable patterns of claim 5, wherein said base is a panel.

8. A cup structure with surfaces of changeable patterns, comprising:
a cup body, having a containing space disposed at the periphery of said cup body;
a reel, contained in a containing space of said cup body, and having a length much longer than the periphery of said cup body, a surface with different patterns or a continuous essay, and a driving shaft and a driven shaft wound separately around both ends of said reel;
a base, disposed at the bottom of said cup body and having a containing space;
a drive circuit, installed in said containing space of said base; and
a motor, installed in said containing space of said base and electrically coupled to said drive circuit, and engaged with said driving shaft and said driven shaft;
such that when said cup structure is in use, said drive circuit controls the rotation of said motor to drive said driving shaft and said driven shaft to rotate and change the portion at the periphery of said cup body surrounded said reel, and said patterns or words on said reel can be rotated to constantly change and display said patterns or texts, so as to satisfy children's curiosity.

9. The cup structure with surfaces of changeable patterns of claim 8, wherein said driven shaft can be substituted by said driving shaft.

10. The cup structure with surfaces of changeable patterns of claim 8, wherein said base, and an elastic member disposed at the periphery of said base, such that when the base is embedded into said containing space, the elasticity of said elastic member fixes said base at an appropriate position, so as to achieve a waterproof effect.
